(19) United States
(12) Patent Application Publication
(10) Pub. No.: US 2026/0351484 A1
(43) Pub. Date: Nov. 5, 2026

(54) METHOD FOR MANUFACTURING SOLID ELECTROLYTIC CAPACITOR

(71) Applicant: Murata Manufacturing Co., Ltd., Nagaokakyo-shi (JP)

(72) Inventors: Yasuhiro TAMATANI, Nagaokakyo-shi (JP); Hiroki KOGA, Nagaokakyo-shi (JP)

(21) Appl. No.: 19/736,045

(22) Filed: Jul. 9, 2026

Related U.S. Application Data
(63) Continuation of application No. PCT/JP2024/043775, filed on Dec. 11, 2024.

(30) Foreign Application Priority Data
Jan. 10, 2024 (JP) 2024-001922

(51) Int. Cl. H01G 9/042; H01G 9/012; H01G 9/15

(52) U.S. Cl. CPC H01G 9/0425; H01G 9/012; H01G 9/15

(57) ABSTRACT

A method for manufacturing a solid electrolytic capacitor, the method including: forming a solid electrolyte layer on an anode foil with a dielectric layer interposed therebetween; forming a silver layer containing a thermoplastic resin on the solid electrolyte layer to form a solid electrolytic capacitor element; stacking a plurality of the solid electrolytic capacitor elements to form a stack; and thermocompression-bonding the stack to remelt the thermoplastic resin and integrate a plurality of the silver layers of the plurality of the solid electrolytic capacitor elements such that no interface between the silver layers is formed in an entire region between adjacent solid electrolytic capacitor elements.

### CROSS REFERENCE TO RELATED APPLICATIONS

The present application is a continuation of International application No. PCT/JP2024/043775, filed Dec. 11, 2024, which claims priority to Japanese Patent Application No. 2024-001922, filed Jan. 10, 2024, the entire contents of each of which are incorporated herein by reference.

### TECHNICAL FIELD

The present disclosure relates to a method for manufacturing a solid electrolytic capacitor.

### BACKGROUND ART

Patent Literature 1 discloses a solid electrolytic capacitor including a structure in which a plurality of capacitor elements are stacked, at least one of the capacitor elements being provided in contact with a cathode extraction electrode, and a sealing resin that seals the plurality of capacitor elements, each of the capacitor elements including: a valve metal base having a porous layer on a surface thereof; a dielectric layer provided on the porous layer; a solid electrolyte layer formed on the dielectric layer; and a cathode layer formed on the solid electrolyte layer, wherein, between the capacitor elements stacked, the cathode layers are directly bonded together on at least a portion of a surface of each of the cathode layers and at least a portion of a surface of the cathode layer of the capacitor element provided in contact with the cathode extraction electrode is directly bonded to the cathode extraction electrode, the sealing resin is provided with a cathode external electrode containing a conductive resin on a surface thereof, and the cathode external electrode is connected to the cathode layer with the cathode extraction electrode in between.

Patent Literature 2 discloses a method for manufacturing a solid electrolytic capacitor, the method including: a preparation step of preparing an element precursor including: a valve metal substrate, a dielectric layer formed on the valve metal substrate, a solid electrolyte layer formed on the dielectric layer, and a conductive paste layer formed from a conductive paste on the solid electrolyte layer; and a stacking step of stacking a plurality of the element precursors so that the conductive paste layers of adjacent element precursors are in contact with each other before the conductive paste of the conductive paste layers dries, thereby obtaining a stack.

Patent Literature 1: JP 6776731 B

Patent Literature 2: JP 2007-194430 A

### SUMMARY OF THE DISCLOSURE

Patent Literature 1 discloses that, between the stacked capacitor elements, the cathode layers are directly bonded to each other on at least a portion of the surfaces of the cathode layers.

Patent Literature 2 discloses that a plurality of the element precursors are stacked before the conductive paste of the conductive paste layers dries and therefore the conductive paste layers of adjacent element precursors are integrated with each other by stacking.

However, in Patent Literature 1, the solid electrolyte layer as well as a carbon layer and a silver layer, which serve as the cathode layer, are each formed by immersion in a liquid material such as a polymer liquid or paste, and thus the outer surface of the resulting cathode layer has a shape that bulges slightly outward. Therefore, in some cases, the cathode layers are not directly bonded to each other throughout the surfaces of the cathode layers between the stacked capacitor elements.

In Patent Literature 2, as in the case of Patent Literature 1, the solid electrolyte layer as well as a carbon layer and a silver layer, which serve as the conductive paste layer, are formed by immersion in a liquid material; therefore, in some cases, the conductive paste layers are not integrated with each other throughout the surfaces of the conductive paste layers.

Accordingly, there is still room for improvement in conventional solid electrolytic capacitors with respect to more reliable integration of the cathode layers of a plurality of solid electrolytic capacitor elements over a wide range and more reliable reduction in ESR (equivalent series resistance) in a stack of solid electrolytic capacitor elements.

The present disclosure has been made to solve the above problems, and an object thereof is to provide a method for manufacturing a solid electrolytic capacitor with a more reliably reduced ESR.

The method for manufacturing a solid electrolytic capacitor of the present disclosure includes forming a solid electrolyte layer on an anode foil with a dielectric layer interposed therebetween; forming a silver layer containing a thermoplastic resin on the solid electrolyte layer to form a solid electrolytic capacitor element; stacking a plurality of the solid electrolytic capacitor elements to form a stack; and thermocompression-bonding the stack to remelt the thermoplastic resin and integrate a plurality of the silver layers of the plurality of the solid electrolytic capacitor elements such that no interface between the silver layers is formed in an entire region between adjacent solid electrolytic capacitor elements.

The present disclosure provides a method for manufacturing a solid electrolytic capacitor with a more reliably reduced ESR.

### BRIEF DESCRIPTION OF THE DRAWINGS

FIG. 1 is a schematic plan view of an example (strip structure) of an assembly of solid electrolytic capacitor elements used in the method for manufacturing a solid electrolytic capacitor according to an embodiment of the present disclosure.

FIG. 2 is a schematic plan view of an example of a step of performing a masking process for conversion on element portions of the assembly of solid electrolytic capacitor elements.

FIG. 3 is a schematic plan view of an example of a step of performing a masking process for polarization (polarization treatment) on the element portions of the assembly of solid electrolytic capacitor elements.

FIG. 4 is a schematic plan view of an example of a step of forming a solid electrolyte layer on each element portion of the assembly of solid electrolytic capacitor elements.

FIG. 5 is a cross-sectional view of an element portion shown in FIG. 4, taken along the line X-X.

FIG. 6 is an enlarged cross-sectional view of a polarized region of the element portion shown in FIG. 5.

FIG. 7 is a schematic plan view of another example (double-opening structure) of the assembly of solid electrolytic capacitor elements used in the method for manufacturing a solid electrolytic capacitor element according to an embodiment of the present disclosure.

FIG. 8 is a schematic plan view of still another example (strip structure) of the assembly of solid electrolytic capacitor elements used in the method for manufacturing a solid electrolytic capacitor element according to an embodiment of the present disclosure.

FIG. 9 is a schematic plan view of still another example (double-opening structure) of the assembly of solid electrolytic capacitor elements used in the method for manufacturing a solid electrolytic capacitor element according to an embodiment of the present disclosure.

FIG. 10 is a schematic plan view of an example of a step of forming a carbon layer on each element portion of the assembly of solid electrolytic capacitor elements.

FIG. 11 is a schematic plan view of an example of a step of forming a silver layer on each element portion of the assembly of solid electrolytic capacitor elements.

FIG. 12 is a schematic diagram of an example of a roller transfer device used for roller transfer of a cathode paste.

FIG. 13 is a schematic diagram of another example of the roller transfer device used for roller transfer of a cathode paste.

FIG. 14 is a schematic perspective view of the appearance of an element portion of the assembly of solid electrolytic capacitor elements to which the cathode paste has been roller-transferred, as viewed from one side.

FIG. 15 is a schematic perspective view of the appearance of the element portion of the assembly of solid electrolytic capacitor elements to which the cathode paste has been roller-transferred, as viewed from the other side.

FIG. 16 is a schematic cross-sectional view of an example of a solid electrolytic capacitor element produced by the method for manufacturing a solid electrolytic capacitor according to an embodiment of the present disclosure, which corresponds to the cross-sectional view of FIG. 5.

FIG. 17 is a schematic cross-sectional view of an example of a step of stacking a plurality of solid electrolytic capacitor elements to form a stack.

FIG. 18 is a schematic cross-sectional view of an example of a stack in which a plurality of silver layers are integrated.

FIG. 19 is a schematic side view of an example of a stack in which a plurality of silver layers are integrated.

FIG. 20 is a schematic end view of an example of a stack in which a plurality of silver layers are integrated, as viewed from one end.

FIG. 21 is a schematic end view of an example of a stack in which a plurality of silver layers are integrated, as viewed from the other end.

FIG. 22 is a schematic plan view of an example of a stack in which a plurality of silver layers are integrated.

FIG. 23 is a schematic cross-sectional view of an example of a solid electrolytic capacitor.

### DESCRIPTION OF THE PREFERRED EMBODIMENTS

The method for manufacturing a solid electrolytic capacitor is described below.

The present disclosure is not limited to the following structures, and may be modified as appropriate without departing from the spirit and scope of the present disclosure. Combinations of two or more preferred structures described below are also within the scope of the present disclosure.

The drawings described below are schematic views, and the dimensions, the scale of aspect ratios, and the like may differ from those of actual products.

Herein, the terms indicating the relationships between elements (e.g., “parallel”, “perpendicular”, and “orthogonal”) and the terms indicating the shapes of elements mean not only the literally exact configurations but also substantially equivalent ranges, for example, ranges including differences of several percent.

The method for manufacturing a solid electrolytic capacitor according to an embodiment of the present disclosure includes forming a solid electrolyte layer on an anode foil with a dielectric layer interposed therebetween; forming a silver layer containing a thermoplastic resin on the solid electrolyte layer to form a solid electrolytic capacitor element; stacking a plurality of the solid electrolytic capacitor elements to form a stack; and thermocompression-bonding the stack to remelt the thermoplastic resin and integrate a plurality of the silver layers of the plurality of the solid electrolytic capacitor elements such that no interface between the silver layers is formed in an entire region between adjacent solid electrolytic capacitor elements.

As described, forming a silver layer containing a thermoplastic resin on a solid electrolyte layer, stacking a plurality of solid electrolytic capacitor elements each including this silver layer to form a stack, and thermocompression-bonding the stack to remelt the thermoplastic resin can lead to more reliable integration of a plurality of the silver layers such that no interface between the silver layers is formed in an entire region between adjacent solid electrolytic capacitor elements. Accordingly, the stack of solid electrolytic capacitor elements can more reliably achieve a low ESR. In addition, the stack can have improved moisture resistance reliability.

Hereinbelow, the method for manufacturing a solid electrolytic capacitor according to an embodiment of the present disclosure is described in more detail with reference to the drawings.

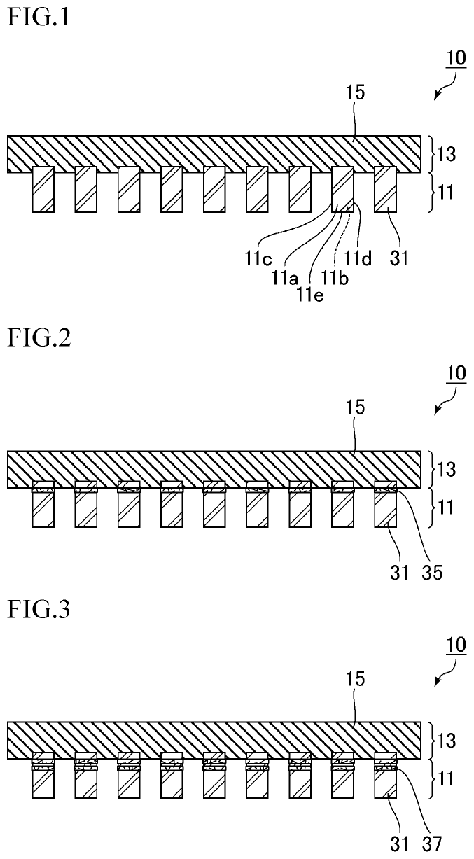

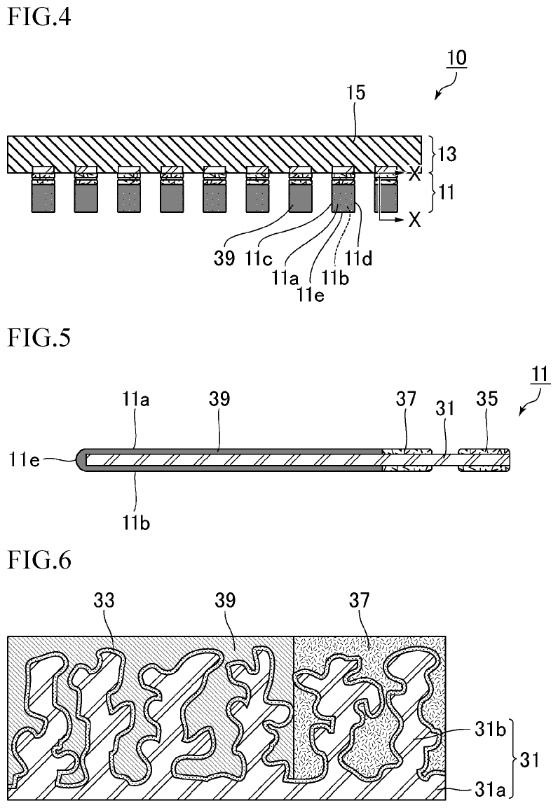

FIG. 1 is a schematic plan view of an example (strip structure) of an assembly of solid electrolytic capacitor elements used in the method for manufacturing a solid electrolytic capacitor according to an embodiment of the present disclosure. FIG. 2 is a schematic plan view of an example of a step of performing a masking process for conversion on element portions of the assembly of solid electrolytic capacitor elements. FIG. 3 is a schematic plan view of an example of a step of performing a masking process for polarization (polarization treatment) on the element portions of the assembly of solid electrolytic capacitor elements. FIG. 4 is a schematic plan view of an example of a step of forming a solid electrolyte layer on each element portion of the assembly of solid electrolytic capacitor elements. FIG. 5 is a cross-sectional view of an element portion shown in FIG. 4, taken along the line X-X. FIG. 6 is an enlarged cross-sectional view of a polarized region of the element portion shown in FIG. 5.

Through the steps shown in FIG. 1 to FIG. 4, a solid electrolyte layer 39 is formed on an anode foil 31 with a dielectric layer 33 interposed therebetween, as shown in FIG. 5 and FIG. 6.

In the present embodiment, as shown in FIG. 4, a case is described in which a solid electrolytic capacitor is produced using an assembly 10, including a plurality of element portions 11, of solid electrolytic capacitor elements; however, the solid electrolytic capacitor of the present disclosure may be produced using a single solid electrolytic capacitor element.

Each element portion 11 has a pair of main surfaces 11a and 11b, a pair of side surfaces 11c and 11d, and one end surface 11e.

Each element portion 11 has a plate shape that is rectangular in plan view, and includes, as shown in FIG. 5 and FIG. 6, an anode foil 31 formed of a valve metal substrate having a porous surface, a dielectric layer 33 provided on a surface of the anode foil 31 (see FIG. 6; not shown in FIG. 5), two insulating masks 35 and 37, which are ring-shaped insulators (extending in a band shape) surrounding the anode foil 31 with the dielectric layer 33 in between, and a solid electrolyte layer 39 provided on the anode foil 31 with the dielectric layer 33 in between in a region from the insulating mask 37 to the end surface 11e. In each element portion 11, the solid electrolyte layer 39 faces the anode foil 31 with the dielectric layer 33 in between.

As shown in FIG. 4, the assembly 10 of solid electrolytic capacitor elements also includes a band-shaped support 13 to which a plurality of the element portions 11 are connected at predetermined intervals.

Each of the steps shown in FIG. 1 to FIG. 4 is described below.

First, as shown in FIG. 1, anode foils 31 each having a shape of a solid electrolytic capacitor element (preferably a rectangular shape) are prepared by a cutting process such as laser processing or punching and, for example, welded to a conveyance substrate 15 serving as the support 13, thereby producing an assembly 10 of solid electrolytic capacitor elements.

As described, the assembly 10 of solid electrolytic capacitor elements includes the conveyance substrate 15 that is formed of a metal material or a resin material and that is provided parallel to a conveyance direction in which the assembly 10 is conveyed in a step of transferring a cathode paste described later, and the element portions 11 are provided only on one side of the conveyance substrate 15. The side surfaces 11c and 11d of each element portion 11 extend in the direction orthogonal to the conveyance direction (the support 13), and the end surface 11e of each element portion 11 extends in parallel with the conveyance direction (the support 13).

Each anode foil 31 constituting an element portion 11 is a valve metal substrate having a porous portion on a surface thereof. As shown in FIG. 6, the anode foil 31 is a thin film (foil) having a rectangular shape in plan view and including a metal substrate portion 31a and a porous portion 31b on the metal substrate portion 31a. A dielectric layer 33 is provided on the surface of the porous portion 31b.

Herein, the term “in plan view” means viewing the anode foil in the direction normal to a main surface thereof.

The valve metal substrate is formed of a valve metal, such as a single metal (e.g., aluminum, tantalum, niobium, titanium, or zirconium) or an alloy containing any of these metals.

The valve metal substrate at least includes a core and a porous portion provided on at least one main surface of the core, and may be, for example, a metal foil having an etched surface or a metal foil having a sintered porous fine powder formed on a surface thereof.

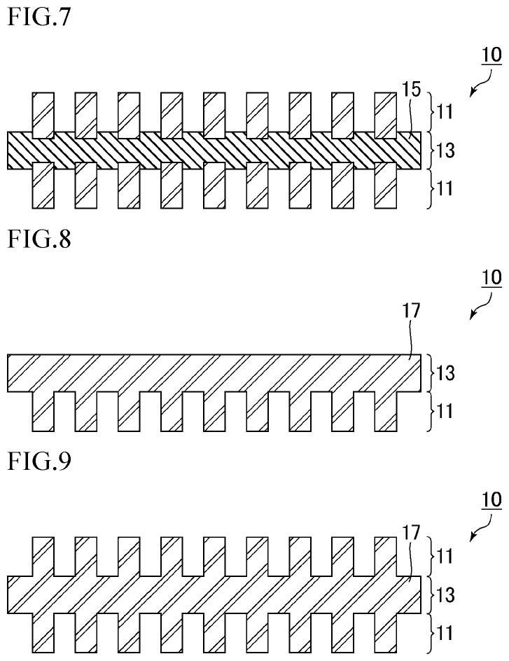

FIG. 7 is a schematic plan view of another example (double-opening structure) of the assembly of solid electrolytic capacitor elements used in the method for manufacturing a solid electrolytic capacitor element according to an embodiment of the present disclosure.

The assembly 10 of solid electrolytic capacitor elements is not limited to the strip structure shown in FIG. 1, and may have a double-opening structure (fishbone structure) as shown in FIG. 7. In this case, the element portions 11 are provided on both sides of the conveyance substrate 15.

A metal material for the conveyance substrate 15 may be aluminum or stainless steel, for example. A resin material for the conveyance substrate 15 may be fluororesin, phenolic resin, or glass-epoxy resin composite material, for example.

In any case, the conveyance substrate 15, unlike the anode foils 31, is a highly rigid component and can prevent the assembly 10 of solid electrolytic capacitor elements from fluttering even in a step of transferring a cathode paste described later.

FIG. 8 is a schematic plan view of still another example (strip structure) of the assembly of solid electrolytic capacitor elements used in the method for manufacturing a solid electrolytic capacitor element according to an embodiment of the present disclosure. FIG. 9 is a schematic plan view of still another example (double-opening structure) of the assembly of solid electrolytic capacitor elements used in the method for manufacturing a solid electrolytic capacitor element according to an embodiment of the present disclosure.

The assembly 10 of solid electrolytic capacitor elements may include no conveyance substrate 15 shown in FIG. 1 and FIG. 7, and may include, as the support 13, a frame 17 provided parallel to the conveyance direction in which the assembly 10 is conveyed in the step of transferring a cathode paste described later, as shown in FIG. 8 and FIG. 9. In this case, the element portions 11 include the same material as the frame 17. Specifically, both are formed of the same valve metal substrate and are formed by cutting the same anode foil. The element portions 11 may be provided only on one side of the frame 17, as shown in FIG. 8 (strip structure), or may be provided on both sides of the frame 17, as shown in FIG. 9 (double-opening structure (fishbone structure)).

Next, as shown in FIG. 2, an insulating mask 35 is applied to each element portion 11 to perform a masking process for conversion.

The insulating mask 35 is formed, for example, by applying a mask material such as a composition containing an insulating resin by screen printing, roller transfer, dispensing, or inkjet printing. Examples of the insulating resin include polyphenylsulfone (PPS), polyethersulfone (PES), cyanate resin, fluororesin (e.g., tetrafluoroethylene, tetrafluoroethylene-perfluoroalkyl vinyl ether copolymer), a composition of soluble polyimidesiloxane and epoxy resin, polyimide resin, a polyamide-imide resin, and derivatives or precursors thereof.

In the case of using not the conveyance substrate 15 but the frame 17, the entire frame 17 is subjected to conversion coating, and polarization between an anode and a cathode is performed separately; therefore, the masking process for conversion is unnecessary.

Next, the assembly 10 of solid electrolytic capacitor elements is subjected to conversion coating (anodizing treatment). This forms an oxide film serving as a dielectric layer on the surface of the valve metal substrate. For example, the dielectric layer includes an oxide of aluminum. In this step, the oxide film is also formed on the pair of side surfaces 11c and 11d and the end surface 11e of each element portion 11, which has been prepared by a cutting process such as laser processing or punching.

A conversion-coated foil on which an oxide of aluminum has already been formed may be used as a valve metal substrate. In this case as well, conversion coating on the valve metal substrate after cutting enables formation of an oxide film on the pair of side surfaces 11c and 11d and the end surface 11e of each element portion 11, which has been prepared by a cutting process.

Next, as shown in FIG. 3, an insulating mask 37 is applied to each element portion 11 to perform a masking process for polarization (polarization treatment) of an anode portion and a cathode portion.

The insulating mask 37 is formed, for example, by applying a mask material such as a composition containing an insulating resin by screen printing, roller transfer, dispensing, or inkjet printing. Examples of the insulating resin include polyphenylsulfone (PPS), polyethersulfone (PES), cyanate resin, fluororesin (e.g., tetrafluoroethylene, tetrafluoroethylene-perfluoroalkyl vinyl ether copolymer), a composition of soluble polyimidesiloxane and epoxy resin, polyimide resin, a polyamide-imide resin, and derivatives or precursors thereof.

Next, as shown in FIG. 4, a solid electrolyte layer 39 is formed on the dielectric layer of each element portion 11. Specifically, the element portion 11 is immersed in a treatment liquid containing a solid electrolyte, whereby the treatment liquid is impregnated into the porous portion of the valve metal substrate. After immersion for a predetermined time period, the element portion 11 is lifted from the treatment liquid and dried at a predetermined temperature for a predetermined time period. Immersion in the treatment liquid, lifting therefrom, and drying are repeated a predetermined number of times, whereby the solid electrolyte layer 39 is formed. The solid electrolyte layer 39 may also be formed by repeating, a predetermined number of times, immersion in a treatment liquid containing a precursor of solid electrolyte (a monomer to form a solid electrolyte by oxidative polymerization) and immersion in a treatment liquid containing an oxidizing agent that oxidatively polymerizes the precursor of solid electrolyte.

The solid electrolyte layer 39 is formed over the entire element portion 11 in a region from the insulating mask 37 to the end surface 11e. The solid electrolyte layer 39 may be in contact with the insulating mask 37, as shown in FIG. 4 to FIG. 6.

The solid electrolyte layer 39 is provided on the dielectric layer 33. As shown in FIG. 6, the solid electrolyte layer 39 is preferably provided so as to fill a plurality of pores (recesses) of the porous portion 31b of the anode foil 31. Still, the solid electrolyte layer 39 may cover part of the outer surface of the dielectric layer 33 and some pores (recesses) of the porous portion 31b of the anode foil 31 may remain unfilled with the solid electrolyte layer 39.

The treatment liquid containing a solid electrolyte may be, for example, a dispersion of a conductive polymer such as a polypyrrole, a polythiophene, or a polyaniline. Preferred among these is a polythiophene, with poly(3,4-ethylenedioxythiophene), referred to as PEDOT, being particularly preferred. The conductive polymer may include a dopant such as polystyrenesulfonic acid (PSS). A conductive polymer film can be formed by applying a dispersion of a conductive polymer to the outer surface of the dielectric layer and drying the dispersion. Alternatively, a liquid containing a polymerizable monomer, such as 3,4-ethylenedioxythiophene, may be used as a treatment liquid containing a precursor of solid electrolyte. The polymerizable monomer may include a dopant such as polystyrenesulfonic acid. The treatment liquid containing a precursor of solid electrolyte may further contain an oxidizing agent. A conductive polymer film can be formed by applying the treatment liquid to the outer surface of the dielectric layer and performing oxidative polymerization (chemical polymerization). This conductive polymer film serves as the solid electrolyte layer 39.

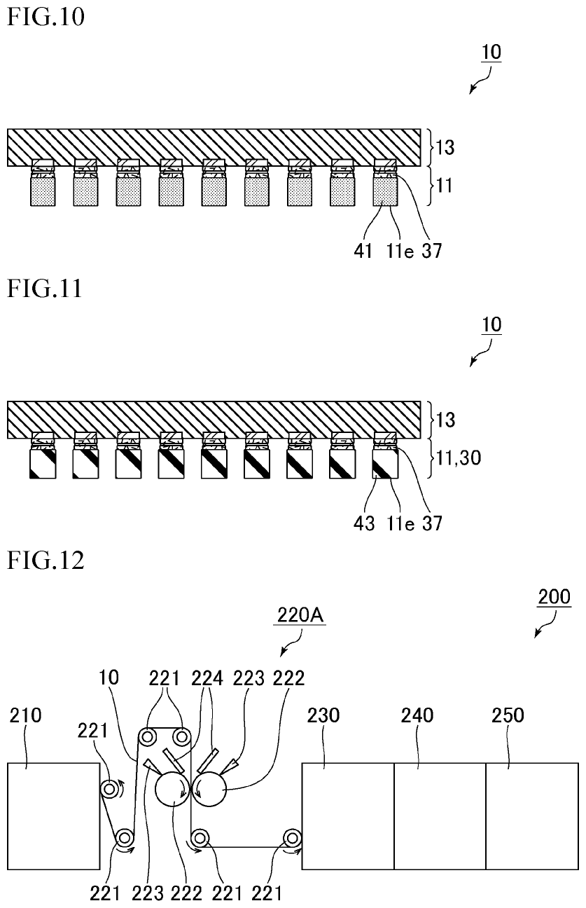

FIG. 10 is a schematic plan view of an example of a step of forming a carbon layer on each element portion of the assembly of solid electrolytic capacitor elements.

Next, a carbon paste serving as a cathode paste is roller-transferred onto each element portion 11 of the assembly 10 of solid electrolytic capacitor elements, thereby forming a carbon layer 41 on each element portion 11, as shown in FIG. 10.

The carbon layer 41 is formed over the entire element portion 11 in a region from the insulating mask 37 to the end surface 11e. As shown in FIG. 10, the carbon layer 41 may completely cover the solid electrolyte layer 39 and may be in contact with the insulating mask 37.

The method of forming a carbon layer 41 (the method of applying the carbon paste) is not limited to roller transfer and may be immersion, for example; however, roller transfer or screen printing is preferred. This enables easier and more reliable formation of a silver layer 43 having a flat outer surface on the carbon layer 41. Application of the carbon paste itself may be eliminated.

FIG. 11 is a schematic plan view of an example of a step of forming a silver layer on each element portion of the assembly of solid electrolytic capacitor elements.

Next, a silver layer 43 containing a thermoplastic resin is formed on the solid electrolyte layer 39 (or the carbon layer 41 if present) to form a solid electrolytic capacitor element 30 in each element portion 11. More specifically, a silver paste serving as a cathode paste is roller-transferred onto each element portion 11 of the assembly 10 of solid electrolytic capacitor elements, thereby forming a silver layer 43 on each element portion 11, as shown in FIG. 11. The silver layer 43 may have a flat outer surface, whereby a plurality of the silver layers can be more reliably integrated such that no interface between the silver layers is formed in an entire region between adjacent solid electrolytic capacitor elements.

Herein, the “silver layer having a flat outer surface” means that a pair of main surfaces of a silver layer, which face each other in the direction of stacking the solid electrolytic capacitor elements, are both flat over the entire area thereof and are parallel to each other. More specifically, the outer surface of a silver layer may be regarded as being flat when the thickness of the cathode portion of a solid electrolytic capacitor element is measured at multiple positions and the standard deviation thereof is 30 μm or less, preferably 20 μm or less. The multiple positions may be five positions, namely upper, middle, lower, left, and right portions of the cathode portion of a solid electrolytic capacitor element.

Herein, the “silver layer having a flat outer surface” refers to a silver layer with at least the outer surface thereof being in a dry state. In other words, the silver layer having a flat outer surface is typically in a state after the silver paste applied onto the solid electrolyte layer has been dried or pre-dried. Therefore, in the present embodiment, the assembly 10 of solid electrolytic capacitor elements and the solid electrolytic capacitor elements 30 are easy to handle in the subsequent steps.

The silver layer 43 is formed over the entire element portion 11 in a region from the insulating mask 37 to the end surface 11e.

The silver layer 43 is preferably formed such that the solid electrolyte layer 39 and the carbon layer 41 are not exposed to the outer surface of the solid electrolytic capacitor element 30. In other words, as shown in FIG. 11, the silver layer 43 preferably completely covers the carbon layer 41. In the case of forming no carbon layer 41, the silver layer 43 preferably completely covers the solid electrolyte layer 39. This can further improve the moisture resistance reliability of a stack of solid electrolytic capacitor elements 30. The silver layer 43 is preferably in contact with the insulating mask 37.

The method of forming a silver layer 43 (the method of applying the silver paste) is not limited to roller transfer, but roller transfer or screen printing is preferred. These methods are suitable for forming a silver layer 43 having a flat outer surface.

With reference to FIG. 12, a roller transfer device used for roller transfer of a cathode paste and a step of roller-transferring the cathode paste are further described.

FIG. 12 is a schematic diagram of an example of a roller transfer device used for roller transfer of a cathode paste.

A roller transfer device 200 shown in FIG. 12 includes an unwinding unit 210, a vertical conveyance roller transfer unit 220A, a pre-drying unit 230, a drying unit 240, and a winding unit 250; the assembly 10 of solid electrolytic capacitor elements fed out from the unwinding unit 210 is conveyed successively to the roller transfer unit 220A, the pre-drying unit 230, and the drying unit 240, and is then wound by the winding unit 250. The assembly 10 is conveyed through the units at a predetermined conveyance speed.

The unwinding unit 210 feeds out the assembly 10 of solid electrolytic capacitor elements wound in a roll around an unwinding reel. The roller transfer unit 220A transfers the cathode paste onto the element portions 11 of the assembly 10 while conveying the assembly 10 fed out from the unwinding unit 210. The pre-drying unit 230 pre-dries the transferred cathode paste by conveying the assembly 10 with the cathode paste being transferred onto the element portions 11. The drying unit 240 heats and dries the pre-dried cathode paste while conveying the assembly 10. The winding unit 250 winds the assembly 10, with the cathode paste being dried, in a roll around a winding reel.

The roller transfer unit 220A includes, along a conveyance path defined by the assembly 10 of solid electrolytic capacitor elements, a plurality of conveyance rollers 221 for conveying the assembly 10, a pair of rollers (transfer rollers) 222 between which the element portions 11 of the assembly 10 are conveyed, and dispensers 223 and squeegees 224 provided for the respective rollers 222.

The pair of rollers 222 are provided on both sides with respect to the assembly 10 of solid electrolytic capacitor elements conveyed by the conveyance rollers 221. Each roller 222 has a circumferential surface made of metal or rubber, and each circumferential surface has a groove into which the cathode paste is fed. The depth of the groove can be set as appropriate in consideration of a desired thickness of the cathode paste applied. The circumferential surfaces of the respective rollers 222 may have no groove and may be flat circumferential surfaces. The circumferential surfaces of the pair of rollers 222 are configured to be in press-contact with the respective main surfaces 11a and 11b of each element portion 11 of the assembly 10. This press contact allows the cathode paste on the circumferential surfaces of the pair of rollers 222 to be transferred onto the main surfaces 11a and 11b of each element portion 11 of the assembly 10.

Each dispenser 223 feeds an appropriate amount of the cathode paste to the corresponding roller 222, and thus the cathode paste does not drip from the circumferential surface of the roller 222. This can minimize consumption of the cathode paste.

Each squeegee 224 is provided at a predetermined distance from the circumferential surface of the corresponding roller 222, and scrapes off the cathode paste adhering to the circumferential surface of the corresponding roller 222 to control the amount of the cathode paste to an appropriate level. In the case of a cathode paste having a low viscosity, scraping with the squeegees 224 may not be performed.

Using the roller transfer device 200 shown in FIG. 12, a carbon paste is first transferred onto the solid electrolyte layer 39 of each element portion 11 of the assembly 10 shown in FIG. 4, and the carbon paste is then dried to form a carbon layer 41 (see FIG. 10).

Similarly, using the roller transfer device 200 shown in FIG. 12, a silver paste is transferred onto the carbon layer 41 of each element portion 11 of the assembly 10 shown in FIG. 10, and the silver paste is then dried to form a silver layer 43 (see FIG. 11).

As described, the step of forming a silver layer 43 preferably includes a step of drying the silver paste. Here, “drying the silver paste” means drying the silver paste such that at least the outer surface of the silver layer 43 is in a dry state as described above, and includes pre-drying the silver paste.

The drying temperature t for the silver paste can be set as appropriate, and is preferably 130 °C to 180 °C, more preferably 140 °C to 160 °C. The drying time for the silver paste can also be set as appropriate, and is preferably 20 minutes to 90 minutes, more preferably 30 minutes to 60 minutes.

More specifically, a cathode paste is first fed onto the pair of rollers 222 of the roller transfer device 200. In this step, the cathode paste is fed from the dispensers 223 onto the respective rollers 222 while the rollers 222 are rotated along the direction of conveying the assembly 10 of solid electrolytic capacitor elements, and the amount of the cathode paste is adjusted by the squeegees 224.

The carbon paste is a conductive paste containing carbon particles serving as a conductive component and a resin component such as epoxy resin or phenolic resin.

The viscosity and thixotropy of the carbon paste are set in consideration of, for example, the shear rate in roller transfer. Since the carbon paste is used in roller transfer, a high-boiling-point solvent is preferably used as an organic solvent. Use of a high-boiling-point solvent allows the carbon paste to dry slowly and can prevent the carbon paste from drying on the circumferential surfaces of the rollers.

The silver paste is a conductive paste containing silver particles serving as a conductive component and a resin component.

The silver paste includes at least a thermoplastic resin as a resin component. This enables formation of a silver layer containing a thermoplastic resin.

The thermoplastic resin is preferably a saturated copolymerized polyester resin. The thermoplastic resin preferably has a glass transition temperature of 0 °C or lower and a weight loss of 0.1% or less when heated from 25 °C to 200 °C by thermogravimetry-differential thermal analysis (TG-DTA). This thermoplastic resin is suitable for integrating a plurality of silver layers of a plurality of solid electrolytic capacitor elements.

The glass transition temperature of the thermoplastic resin is preferably 25 °C or lower, more preferably 0 °C or lower.

The thermoplastic resin may be amorphous without a glass transition point.

The weight loss of the thermoplastic resin is preferably 0.1% or less, more preferably 0.05% or less, when heated from 25 °C to 200 °C by TG-DTA.

The amount of the thermoplastic resin in the whole amount of the silver paste may be, for example, 5% by mass to 25% by mass.

The viscosity and thixotropy of the silver paste are set in consideration of, for example, the shear rate in roller transfer. The silver paste is preferably such that the viscosity is low at a high shear rate (20 to 250 (l/s)) and is high at a low shear rate (0.01 to 0.5(l/s)). As in the case of the carbon paste, the silver paste is used in roller transfer; thus, a high-boiling-point solvent is preferably used as an organic solvent. Use of a high-boiling-point solvent allows the silver paste to dry slowly and can prevent the silver paste from drying on the circumferential surfaces of the rollers.

Next, the assembly 10 of solid electrolytic capacitor elements including the element portions 11 with the solid electrolyte layer 39 formed thereon is conveyed between the pair of rollers 222 with the cathode paste being fed thereto. In this step, the assembly 10 is conveyed in the direction in which the support 13 extends such that only the element portions 11 are sandwiched between the pair of rollers 222, and thereby the cathode paste is continuously printed on the element portions 11. Between the pair of rollers 222 is conveyed only a region from the insulating mask 37 to the end surface 11e of each element portion 11, in which the carbon layer 41 (or the solid electrolyte layer 39 when the carbon layer 41 is not formed) is formed.

The speed of conveying the assembly 10 is 20 to 150 mm/s, for example. The rotation speed (rpm) of each roller 222 is calculated from the conveyance speed and the diameter of the roller. The gap (mm) between the pair of rollers 222 is set in consideration of the thickness of the element portions 11 (the thickness after the solid electrolyte layer is formed), and is at least set to be larger than the thickness of the anode foils.

The thickness of each anode foil may be 100 μm to 150 μm, and is preferably 110 μm to 130 μm.

The thickness of each element portion 11 (the thickness after the solid electrolyte layer is formed) may be 110 μm to 180 μm, and is preferably 120 μm to 160 μm.

As shown in FIG. 12, the assembly 10 of solid electrolytic capacitor elements may be conveyed between the pair of rollers 222 while being conveyed in the direction orthogonal to the horizontal direction.

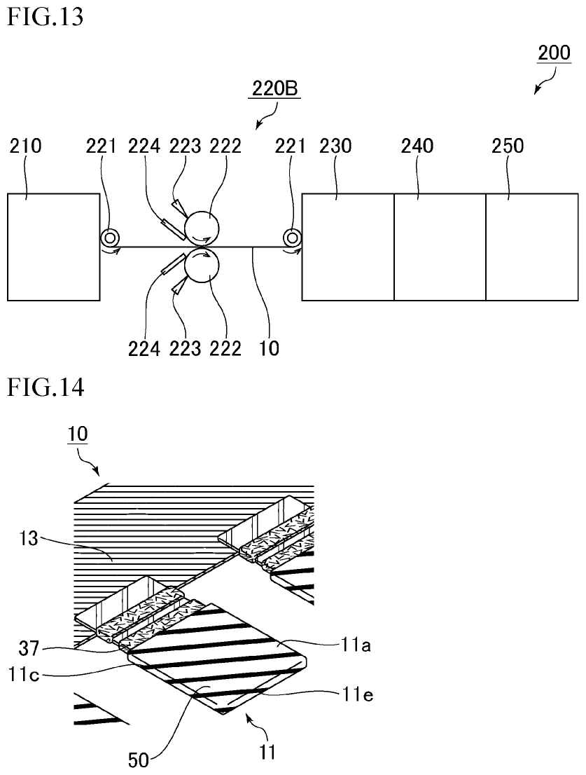

FIG. 13 is a schematic diagram of another example of the roller transfer device used for roller transfer of a cathode paste.

As shown in FIG. 13, the roller transfer device 200 may include a horizontal conveyance roller transfer unit 220B instead of the vertical conveyance roller transfer unit 220A. Similar to the vertical conveyance roller transfer unit 220A, the horizontal conveyance roller transfer unit 220B includes, along a conveyance path formed by the assembly 10 of solid electrolytic capacitor elements, a plurality of conveyance rollers 221 for conveying the assembly 10, a pair of rollers (transfer rollers) 222 between which the element portions 11 of the assembly 10 are conveyed, and dispensers 223 and squeegees 224 provided for the respective rollers 222.

In the horizontal conveyance roller transfer unit 220B, the assembly 10 of solid electrolytic capacitor elements is conveyed between the pair of rollers 222 while being conveyed in the horizontal direction.

FIG. 14 is a schematic perspective view of the appearance of an element portion of the assembly of solid electrolytic capacitor elements to which the cathode paste has been roller-transferred, as viewed from one side. FIG. 15 is a schematic perspective view of the appearance of the element portion of the assembly of solid electrolytic capacitor elements to which the cathode paste has been roller-transferred, as viewed from the other side.

The cathode paste on the pair of rollers 222 is transferred onto the pair of main surfaces 11a and 11b of the element portion 11, and layers of the cathode paste transferred onto the pair of main surfaces 11a and 11b are connected on the pair of side surfaces 11c and 11d and the end surface 11e. More specifically, the layers of the cathode paste overflow from between the respective rollers 222 and the respective main surfaces 11a and 11b, and then wrap around from the main surfaces 11a and 11b onto the side surfaces 11c and 11d and the end surface 11e, coming into contact with each other; thereby, the layers of the cathode paste are connected on the side surfaces 11c and 11d and the end surface 11e. Accordingly, as shown in FIG. 14 and FIG. 15, the cathode paste layers 50 on the main surfaces 11a and 11b, the side surfaces 11c and 11d, and the end surface 11e are connected to each other seamlessly (with no discontinuity) without forming interfaces at boundaries therebetween.

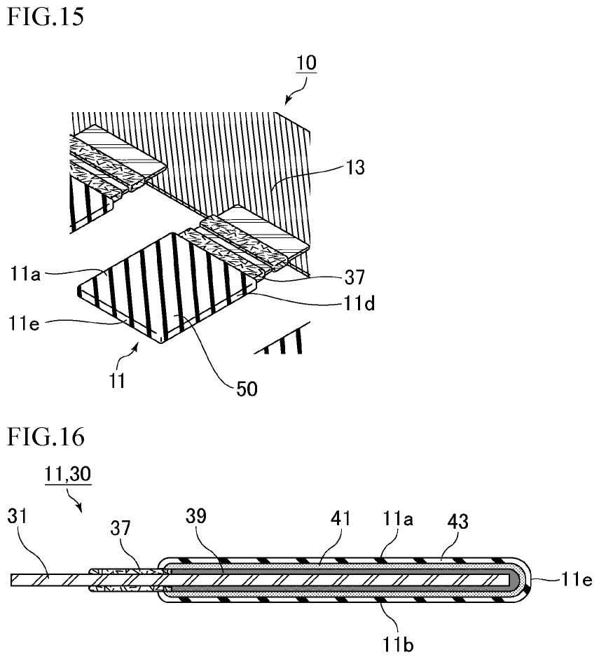

FIG. 16 is a schematic cross-sectional view of an example of a solid electrolytic capacitor element produced by the method for manufacturing a solid electrolytic capacitor according to an embodiment of the present disclosure, which corresponds to the cross-sectional view of FIG. 5.

As a result, as shown in FIG. 16, the solid electrolytic capacitor element 30 is formed at each element portion 11. The silver layers 43 on the individual surfaces of the solid electrolytic capacitor element 30 are connected to each other seamlessly (with no discontinuity) without forming interfaces at boundaries therebetween.

In each element portion 11, the solid electrolyte layer 39, the carbon layer 41, and the silver layer 43 (or the solid electrolyte layer 39 and the silver layer 43 when the carbon layer 41 is not formed) in a region from the insulating mask 37 to the end surface 11e function as a cathode, while the anode foil 31 in the opposite region functions as an anode. Accordingly, use of each element portion 11 enables manufacture of a two-terminal solid electrolytic capacitor.

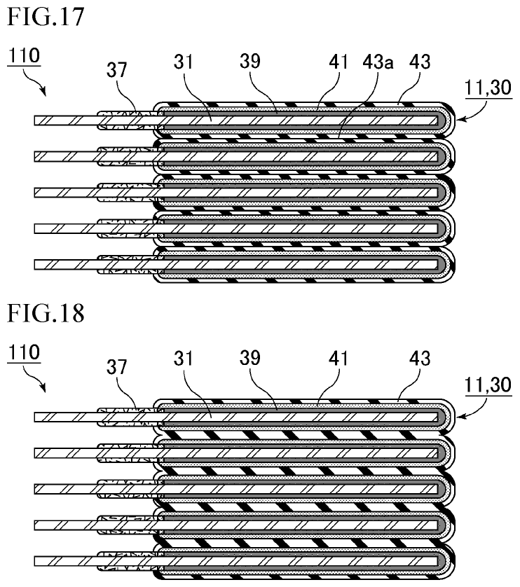

FIG. 17 is a schematic cross-sectional view of an example of a step of stacking a plurality of solid electrolytic capacitor elements to form a stack.

Thereafter, a plurality of the assemblies 10 are stacked, so that a plurality of solid electrolytic capacitor elements 30 (element portions 11) are stacked and resultantly a stack 110 is formed, as shown in FIG. 17. At this stage, the plurality of solid electrolytic capacitor elements 30 are merely superposed on each other, and interfaces 43a are present in the entire region between the silver layers 43. In this step, a conductive adhesive is unnecessary between adjacent solid electrolytic capacitor elements 30.

FIG. 18 is a schematic cross-sectional view of an example of a stack in which a plurality of silver layers are integrated.

Next, the stack 110 is thermocompression-bonded to remelt the thermoplastic resin in each silver layer 43. As a result, as shown in FIG. 18, a plurality of the silver layers 43 of the plurality of solid electrolytic capacitor elements 30 are more reliably integrated, and the interfaces between the silver layers 43 disappear in the entire region between adjacent solid electrolytic capacitor elements 30. This can more reliably reduce the ESR of the stack 110 and can improve the moisture resistance reliability of the stack 110. In addition, a conductive adhesive is unnecessary, which can reduce the cost and can reduce the thickness (reduce the height) of the stack 110 in the stacking direction.

The temperature T in thermocompression bonding the stack 110 can be set as appropriate, and is preferably higher than the drying temperature t for the silver paste described above. Specifically, the difference between the temperature T and the drying temperature t (T−t) is preferably 50 °C to 150 °C, more preferably 80 °C to 100 °C

The temperature T in thermocompression bonding the stack 110 is preferably 150 °C to 250 °C, more preferably 180 °C to 230 °C. The time period of thermocompression bonding the stack 110 can be set as appropriate, and is preferably 10 seconds to 90 seconds, more preferably 20 seconds to 60 seconds. The pressure of thermocompression bonding the stack 110 can also be set as appropriate, and is preferably 5 N to 50 N, more preferably 10 N to 30 N, per stack.

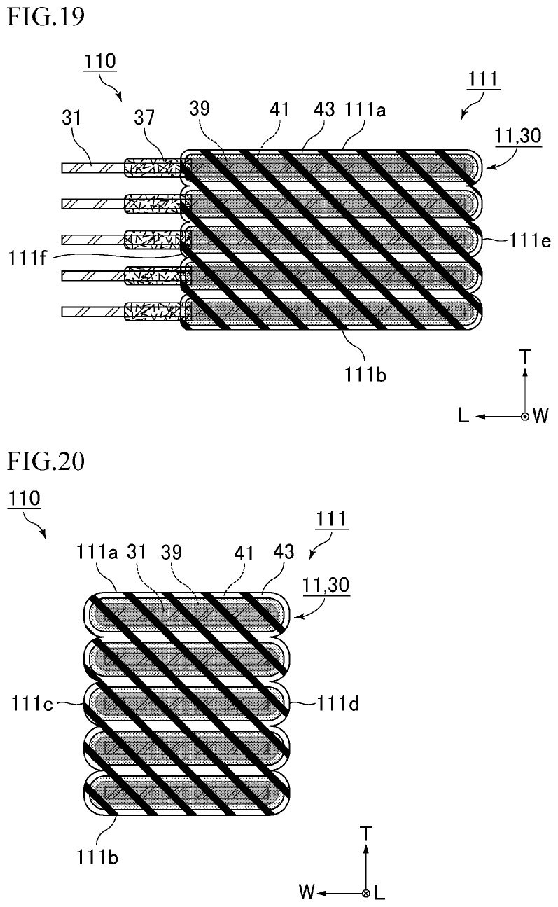

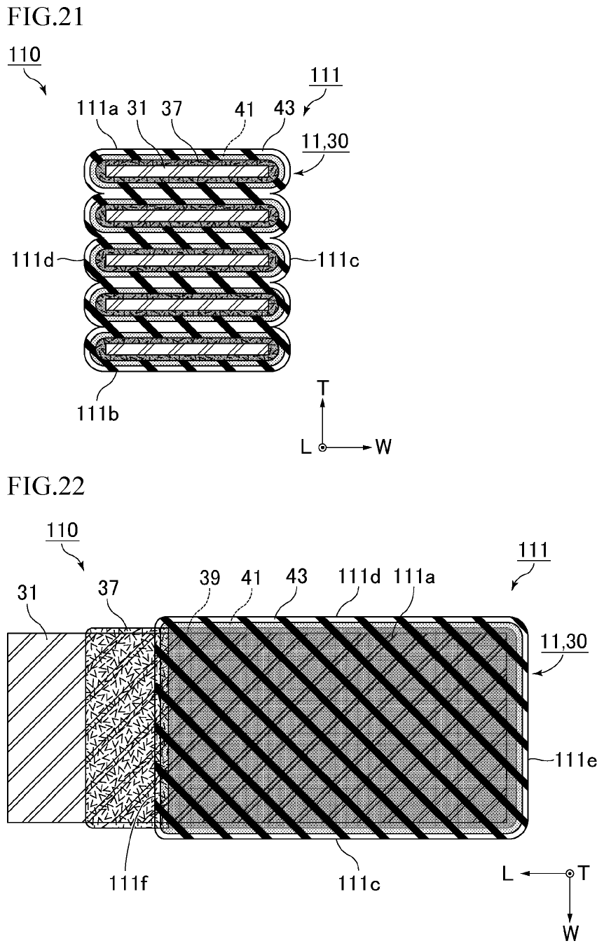

FIG. 19 is a schematic side view of an example of a stack in which a plurality of silver layers are integrated. FIG. 20 is a schematic end view of an example of a stack in which a plurality of silver layers are integrated, as viewed from one end. FIG. 21 is a schematic end view of an example of a stack in which a plurality of silver layers are integrated, as viewed from the other end. FIG. 22 is a schematic plan view of an example of a stack in which a plurality of silver layers are integrated.

As shown in FIG. 19 to FIG. 22, the stack 110 after thermocompression bonding includes a capacitance-forming portion 111 having a rectangular parallelepiped outer shape. The capacitance-forming portion 111 corresponds to a capacitor portion of the solid electrolytic capacitor excluding external terminals, encapsulating portions, and electrode lead portions, and includes a first main surface 111a and a second main surface 111b facing each other in the stacking direction (height direction) T of the solid electrolytic capacitor elements 30, a first side surface 111c and a second side surface 111d facing each other in the width direction W, and a first end surface 111e and a second end surface 111f facing each other in the length direction L.

As shown in FIG. 19 to FIG. 22, preferably, the silver layers 43 on the six faces of the capacitance-forming portion 111 are integrated. This can further improve the moisture resistance reliability of the stack 110.

More specifically, as shown in FIG. 19, on the first side surface 111c and the second side surface 111d, the whole cathode of the stack 110 (capacitance-forming portion 111) is covered with the silver layer 43, and the solid electrolyte layers 39 and the carbon layers 41 are not exposed. The silver layer 43 has unevenness by which the individual solid electrolytic capacitor elements 30 can be distinguished from each other, but the silver layer portions form a planar connection between adjacent solid electrolytic capacitor elements 30. The anode foils 31 are exposed in a region between the insulating mask 37 and the anode end of the stack 110.

As shown in FIG. 20, also on the first end surface 111e, the whole cathode of the stack 110 (capacitance-forming portion 111) is covered with the silver layer 43, and the solid electrolyte layers 39 and the carbon layers 41 are not exposed. The silver layer 43 has unevenness by which the individual solid electrolytic capacitor elements 30 can be distinguished from each other, but the silver layer portions form a continuous surface between adjacent solid electrolytic capacitor elements 30.

As shown in FIG. 21, also on the second end surface 111f, the whole cathode of the stack 110 (capacitance-forming portion 111) is covered with the silver layer 43, and the solid electrolyte layers 39 and the carbon layers 41 are not exposed. The silver layer 43 has unevenness by which the individual solid electrolytic capacitor elements 30 can be distinguished from each other, but the silver layer portions form a continuous surface between adjacent solid electrolytic capacitor elements 30. On the other hand, the anode foils 31 and the insulating masks 37 are not covered with the silver layer 43 and are exposed.

As shown in FIG. 22, also on the first main surface 111a and the second main surface 111b, the whole cathode of the stack 110 (capacitance-forming portion 111) is covered with the silver layer 43, and the solid electrolyte layer 39 and the carbon layer 41 are not exposed. The anode foil 31 is exposed in a region between the insulating mask 37 and the anode end of the stack 110.

Thereafter, the anode and the cathode of the stack 110 are connected to respective lead frames.

The stack 110 is then encapsulated, and the lead frames are formed and trimmed to provide external terminals.

As a result, a solid electrolytic capacitor is produced. This solid electrolytic capacitor is a two-terminal solid electrolytic capacitor.

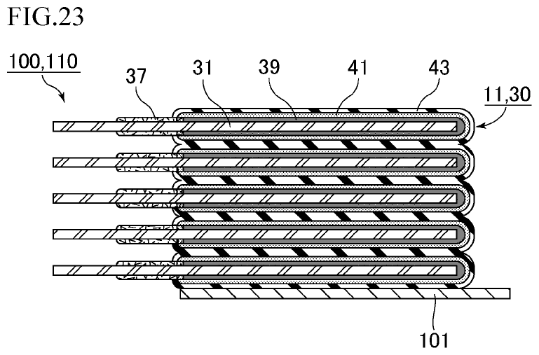

FIG. 23 is a schematic cross-sectional view of an example of a solid electrolytic capacitor.

A solid electrolytic capacitor 100 shown in FIG. 23 is a two-terminal solid electrolytic capacitor and has a structure in which a lead frame 101 is positioned at the bottom and solid electrolytic capacitor elements 30 are sequentially stacked on the lead frame 101.

FIG. 23 shows only characteristic features of the structure of the solid electrolytic capacitor, and details of features such as connection between the anode and an external portion and resin encapsulation are not described in detail herein; however, these features may be those used in common solid electrolytic capacitors.

The lead frame 101 is not necessarily disposed at the lowest layer and may be interposed between the cathodes of two solid electrolytic capacitor elements 30. Accordingly, the cathodes of a plurality of solid electrolytic capacitor elements 30 may be superposed to form a stack of the plurality of solid electrolytic capacitor elements 30; then a lead frame 101 may be placed on the stack; and subsequently another stack of a plurality of solid electrolytic capacitor elements 30 may be superposed thereon such that the cathode of a solid electrolytic capacitor element 30 is superposed on the lead frame 101, whereby a stack is produced in which the lead frame is interposed between the cathodes, followed by application of heat and pressure to the stack.

### REFERENCE SIGNS LIST

10: assembly of solid electrolytic capacitor elements
11: element portion
11a, 11b: main surface of element portion
11c, 11d: side surface of element portion
11e: end surface of element portion
13: support
15: conveyance substrate
17: frame
30: solid electrolytic capacitor element
31: anode foil
31a: metal substrate
31b: porous portion
33: dielectric layer
35, 37: insulating mask
39: solid electrolyte layer
41: carbon layer
43: silver layer
43a: interface between silver layers
50: cathode paste layer
100: solid electrolytic capacitor
101: lead frame
110: stack

1111: capacitance-forming portion
111a: first main surface
111b: second main surface
111c: first side surface
111d: second side surface
111e: first end surface
111f: second end surface
200: roller transfer device
210: unwinding unit
220A: vertical conveyance roller transfer unit
220B: horizontal conveyance roller transfer unit
221: conveyance roller
222: roller (transfer roller)
223: dispenser
224: squeegee
230: pre-drying unit
240: drying unit
250: winding unit

1. A method for manufacturing a solid electrolytic capacitor, the method comprising:
forming a solid electrolyte layer on an anode foil with a dielectric layer interposed therebetween;
forming a silver layer containing a thermoplastic resin on the solid electrolyte layer to form a solid electrolytic capacitor element;
stacking a plurality of the solid electrolytic capacitor elements to form a stack; and
thermocompression-bonding the stack to remelt the thermoplastic resin and integrate a plurality of the silver layers of the plurality of the solid electrolytic capacitor elements such that no interface between the silver layers is formed in an entire region between adjacent solid electrolytic capacitor elements.

2. The method for manufacturing a solid electrolytic capacitor according to claim 1, further comprising forming a carbon layer between the solid electrolyte layer and the silver layer,
wherein the silver layer is formed such that the solid electrolyte layer and the carbon layer are not exposed to an outer surface of the solid electrolytic capacitor element.

3. The method for manufacturing a solid electrolytic capacitor according to claim 1, wherein
the stack includes a capacitance-forming portion having a rectangular parallelepiped shape, and
the silver layer is on six faces of the capacitance-forming portion and are integrated.

4. The method for manufacturing a solid electrolytic capacitor according to claim 1, wherein the thermoplastic resin includes a saturated copolymerized polyester resin.

5. The method for manufacturing a solid electrolytic capacitor according to claim 1, wherein the thermoplastic resin has a glass transition temperature of 0 °C or lower and a weight loss of 0.1% or less when heated from 25 °C to 200 °C by thermogravimetric differential thermal analysis.

6. The method for manufacturing a solid electrolytic capacitor according to claim 1, wherein the forming of the silver layer includes applying a silver paste containing the thermoplastic resin onto the solid electrolyte layer.

7. The method for manufacturing a solid electrolytic capacitor according to claim 6, wherein
the forming of the silver layer includes drying the silver paste, and
a temperature in the thermocompression-bonding of the stack is higher than a temperature in the drying of the silver paste.

8. The method for manufacturing a solid electrolytic capacitor according to claim 6, wherein the silver paste is applied onto the solid electrolyte layer by roller transfer or screen printing.

9. The method for manufacturing a solid electrolytic capacitor according to claim 1, wherein the silver layer is formed so as to have a flat outer surface.

10. The method for manufacturing a solid electrolytic capacitor according to claim 9, wherein the flat outer surface of the silver layer is such that a standard deviation of a thickness of a cathode portion of the solid electrolytic capacitor element, measured at five positions, is 30 μm or less.

11. The method for manufacturing a solid electrolytic capacitor according to claim 1, wherein forming of the silver layer includes applying a cathode paste to a pair of main surfaces, a pair of side surfaces, and an end surface of the solid electrolytic capacitor element such that the silver layer is connected on the main surfaces, the side surfaces, and the end surface without forming an interface at boundaries therebetween.

12. The method for manufacturing a solid electrolytic capacitor according to claim 1, wherein the plurality of solid electrolytic capacitor elements are stacked without a conductive adhesive between adjacent solid electrolytic capacitor elements.

13. The method for manufacturing a solid electrolytic capacitor according to claim 1, wherein the thermocompression-bonding of the stack is performed at a temperature of 150 °C to 250 °C

14. The method for manufacturing a solid electrolytic capacitor according to claim 1, wherein the thermocompression-bonding of the stack is performed at a pressure of 5 N to 50 N per stack.

15. The method for manufacturing a solid electrolytic capacitor according to claim 6, wherein an amount of the thermoplastic resin is 5% by mass to 25% by mass based on a total mass of the silver paste.

16. The method for manufacturing a solid electrolytic capacitor according to claim 7, wherein the drying of the silver paste is performed at a temperature of 130 °C to 180 °C.

17. The method for manufacturing a solid electrolytic capacitor according to claim 7, wherein a difference obtained by subtracting the temperature in the drying of the silver paste from the temperature in the thermocompression-bonding of the stack is 50 °C to 150 °C.

18. The method for manufacturing a solid electrolytic capacitor according to claim 8, wherein the plurality of solid electrolytic capacitor elements are provided as an assembly including a plurality of element portions connected to a support, and the silver paste is applied to the element portions by roller transfer while conveying the assembly in a direction in which the support extends.

19. The method for manufacturing a solid electrolytic capacitor according to claim 18, wherein the support includes a conveyance substrate formed of a metal material or a resin material and provided parallel to a conveyance direction in which the assembly is conveyed.

20. The method for manufacturing a solid electrolytic capacitor according to claim 18, wherein the support includes a frame provided parallel to a conveyance direction in which the assembly is conveyed, and the element portions and the frame are formed of a same valve metal substrate.
